(19) United States
(12) Patent Application Publication
(10) Pub. No.: US 2005/0025384 A1
(43) Pub. Date: Feb. 3, 2005

(54) Method for eliminating a color edge and apparatus thereof

(76) Inventor: Ting Ming-Jeu, Taichung City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/872,862

(22) Filed: Jun. 21, 2004

(30) Foreign Application Priority Data
Jul. 29, 2003 (TW) 092120593

(51) Int. Cl. G06K 9/40; G06K 9/00; H04N 1/40

(52) U.S. Cl. 382/268; 382/162; 348/222.1

(57) ABSTRACT

A method for eliminating a color edge on a digital color image includes finding a boundary between two color blocks on the digital color image, and finding a suitable parameter to adjust the color saturation of this boundary so as to prevent an undesired color from appearing on the boundary.

This application claims the benefit of Taiwan application Ser. No. 092120593, filed on Jul. 29, 2003, the subject matter of which is incorporated herein by reference.

### BACKGROUND OF THE INVENTION

1. Field of the Invention

The invention relates in general to a digital color image processing method and an apparatus thereof, and more particularly to a method for eliminating a color edge of a color image and an apparatus thereof.

2. Description of the Related Art

The sensor device, such as a CCD (charge coupled device) or a CMOS (Complementary Metal-Oxide Semiconductor) sensor device, is currently used in the digital still camera (DSC). A sensor module with 640×480 pixels will be described as an example. FIG. 1 is a schematic illustration showing a sensor module with 640×480 pixels. As shown in FIG. 1, the sensor module 100 is composed of 640×480 sensor devices 105. A color filter 110 is disposed on each of the sensor devices 105, which only allows for the monochromatic (e.g., red (R), green (G), or blue (B)) light beam to pass therethrough. The red (R), green (G) and blue (B) color filters may be arranged according to the arrangement manner of the Bayer array filter.

Hence, when the light ray passes through the color filter and then reaches the sensor device 105 of the sensor module 100, each sensor device 105 can only sense the luminance of the monochromatic (R or G or B). In FIG. 1, the color of the light beam sensed by the sensor device 105 is represented by R, G or B. The sensor device 105 correspondingly outputs the induction current according to the luminance level of the sensed color of light ray. Thereafter, the digital camera forms the final digital color image according to the induction current.

Since each sensor device 105 can only sense one of the RGB light rays and generate the induction current, the luminance levels obtained by other sensor devices for sensing other colors of ambient light has to be used in conjunction with interpolation because the color of each pixel is composed by the R, G, and B values.

When some pixels are located on a junctional portion between color blocks of the digital color image, the color of the pixel derived using the interpolation method may include undesired colors. In this context, this phenomenon is defined as a color edge of the digital color image.

FIG. 2 is a schematic illustration showing two adjacent color blocks represented by R or G or B in the CCD sensor device. As shown in FIG. 2, two adjacent color blocks 200 and 210 respectively represent red and green color blocks. Thus, only R has the value of (255) among the R, G and B values represented by each sensor device on the red color block 200, and only G has the value of (255) among the R, G and B values represented by each sensor device on the green color block 210.

In the two color blocks 200 and 210, the color edge tends to appear at positions of B₂₄, B₄₄ and B₆₄ on the junctional portion between the color blocks 200 and 210. Taking the B₄₄ position as an example, when the color at the B₄₄ position is calculated by way of interpolation, the R and G values around the B₄₄ position are respectively averaged to determine the R and G values at the B₄₄ position. The color at the B₄₄ position may be determined according to the determined R and G values in conjunction with the B value at the B₄₄ position.

Thus, the derived R, G and B values at the B₄₄ position using the interpolation method are:
R=(255(R₃₃)+0(R₃₅)+255(R₅₃)+0(R₅₅))/4=152.5,
G=(0(G₃₄)+0(G₅₄)+0(G₄₃)+255(G₄₅))/4=63.75, and
B=0(B₄₄).

Hence, the R, G, and B values which are determined by way of interpolation at the B₄₄ position are 152.5, 63.75, and 0, respectively. That is, the color at the B₄₄ position is close to the yellow color. Because the B₄₄ position belongs to the block 200 to be formed into red, the R and G values of the block 200 to be formed into green are utilized when the R and G values at the B₄₄ position are determined by way of interpolation. That is, R and G values represented at the R₃₅, R₅₅, and G₄₅ positions cannot be the desired R and G values at the B₄₄ position.

When the block 200 representative of red has the yellow color at the boundary of B₄₄ position, the undesired color appears on the boundary of the red block 200 in the digital color image, which is referred to as the color edge.

Therefore, when the color edge appears at the junctional portion between the red block 200 and the green block 210 in the digital color image, the boundary between the blocks 200 are 210 is blurred. Similarly, when the color edges appear on each block in the digital color image, the smoothness of the overall digital color image becomes poor.

### SUMMARY OF THE INVENTION

It is therefore one of the objects of the invention to provide a method for eliminating a color edge on a digital color image and an apparatus thereof. According to the invention, the undesired color on the junctional portion between blocks in the color image is effectively eliminated, and the quality of the overall digital color image is enhanced.

The invention achieves the above-identified object by providing a method including the steps of finding a boundary at a junctional portion between two color blocks in a digital color image, and finding a suitable parameter to adjust the chrominance of the boundary.

According to a preferred embodiment of the invention, in the step of finding the boundary between two color blocks in the color image, the boundary is found according to luminance differences between a pixel and its ambient pixels in the digital color image, and then the chrominance on the boundary is adjusted to eliminate the color edge at the junctional portion between two color blocks.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a schematic illustration showing a sensor module with 640×480 pixels.

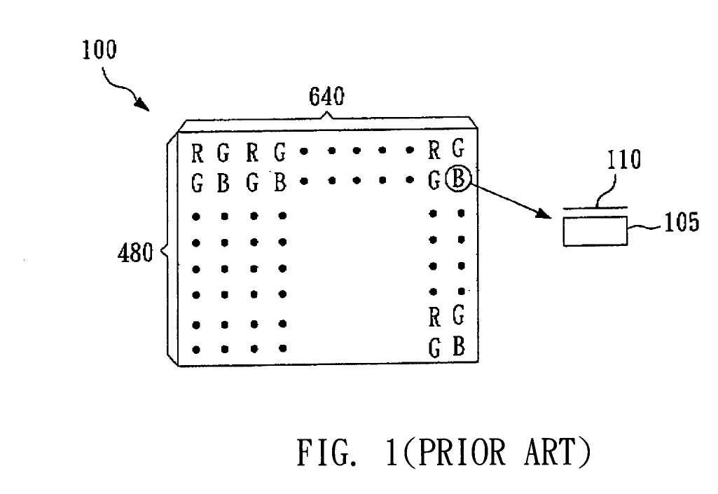

FIG. 2 is a schematic illustration showing two adjacent color blocks represented by R or G or B in the CCD sensor device.

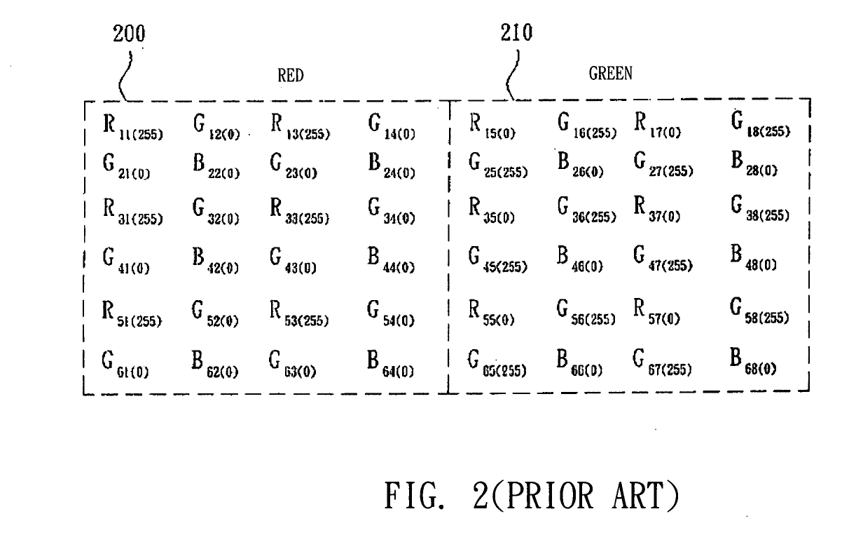

FIG. 3 is a schematic illustration showing that the R, G and B values representative of the sensor device in the preferred embodiment of the invention is color-converted into the pixel luminance, the chrominance of the digital color image.

FIG. 4 is a chart showing that the unit luminance difference amount E(Y_{ab}) between the Y_{ab} pixel and its ambient pixels in the digital color image is adjusted according to different variable parameters (Gains).

### DETAILED DESCRIPTION OF THE INVENTION

In the method of this invention, a boundary between two color blocks on a digital color image is found, and then the color of the boundary pixel representative of the color block is eliminated in order to avoid the color edge on the boundary pixel.

The boundary between two adjacent color blocks on the digital color image can be determined according to the luminance differences between the pixel and its ambient pixels on the digital color image by using a first-order or even a higher-order high-pass filter. Additionally, color conversion of R, G and B values of each pixel on the digital color image into the color luminance and chrominance (corresponding to the hue and saturation) of each pixel is well-known in the art. Thus, the preferred embodiment of the invention first applies a sensor device and an interpolation method to obtain the R, G and B values of each pixel corresponding to the digital color image. The R, G and B values of each pixel are then converted into the luminance (Y) and chrominance (C_{b},Cᵣ) of the pixel by way of color converting. Next, in this embodiment, the unit luminance differences between each pixel and its ambient pixels are derived according to the first-order derivative, thereby determining the boundary between the color blocks in the digital color image.

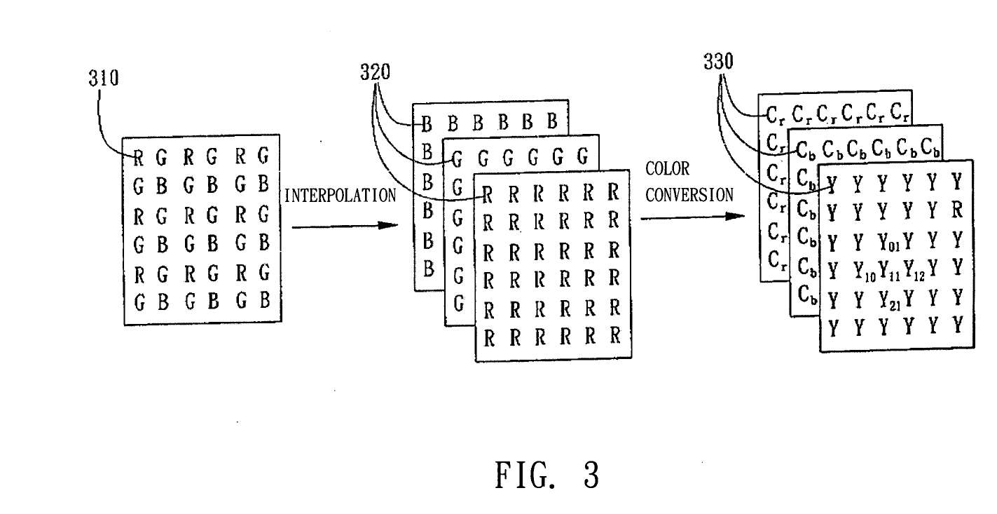

FIG. 3 is a schematic illustration showing that the R, G and B values sensed by the sensor device in the preferred embodiment of the invention are color-converted into the pixel luminance, and the chrominance (C_{b},Cᵣ) of each pixel. As shown in FIG. 3, after the sensor devices have sensed the colors, different R, G or B values 310 representative of these devices are obtained. Thereafter, the R, G and B values 320 of each pixel on the digital color image that is finally obtained by taken the color image may be obtained according to the R or G or B values 310 representative of each sensor device by way of interpolation. Finally, the R, G, B values 320 of each pixel on the digital color image are converted into the luminance (Y), first color factor (C_{b}), and second color factor (Cᵣ) 330 representative of each pixel on the digital color image by way of color conversion.

After the luminance level (Y) of each pixel on the digital color image is found, the boundary between adjacent color blocks on the digital color image can be found according to the luminance differences between each pixel and its ambient pixels. Taking the pixel with the luminance of Y₁₁ of FIG. 3 as an example, the unit difference E(Y₁₁) between the Y₁₁ pixel and its ambient pixels corresponds to the increment ratio of the luminance at the Y₁₁ pixel in the horizontal direction from the adjacent Y₁₀ pixel to the adjacent Y₁₂ pixel, and to the increment ratio of the luminance at the Y₁₁ pixel in the vertical direction from the adjacent Y₀₁ pixel to the adjacent Y₂₁ pixel. That is,
E(Y₁₁)==(|Y₁₂−Y₁₀|+|Y₂₁−Y₀₁|)÷2.

In a microscopic view, the E(Y₁₁) value represents the luminance variation between the pixel and its adjacent pixels in the digital color image. In a macroscopic view, the E(Y₁₁) value represents the boundary between the color blocks in the digital color image. In addition, the E(Y₁₁) value will also represent the apparent degree of the boundary between two color blocks on the digital color image. In other words, the greater the E(Y₁₁) value is, the more apparent the boundary between two adjacent color blocks is, while the smaller the E(Y₁₁) value is, the smaller the color difference between two adjacent color blocks is.

Therefore, as the E(Y₁₁) value gets greater, it is represented that the boundary does exist between two adjacent color blocks on the digital color image as well as that the more apparent color edge does exist between two adjacent color blocks, and vice versa.

As a result, according to the above-mentioned description, the magnitude of the E(Y₁₁) value will determine the modification degrees of C_{b} and Cᵣ. In the preferred embodiment of the invention, a smooth descending function such as a cosine function (Cos)ⁿ serves as the variable parameter (Gain) for modifying Cb and Cr, and the variable parameter varies to modify C_{b} and Cᵣ according to the E(Y₁₁) value. The modified C_{b11} and Cᵣ₁₁ will be:
C_{b11}′=Cos((E(Y₁₁)÷2Q)π)ⁿ×C_{b11}, and
Cᵣ₁₁′=Cos((E(Y₁₁)÷2Q)π)ⁿ×Cᵣ₁₁.

In addition, the greater E(Y₁₁) value represents that the boundary does exist between two adjacent color blocks on the digital color image and also that the more apparent color edge does appear on the two adjacent color blocks. Hence, when the E(Y₁₁) value gets larger, the downward modification amounts for C_{b11} and Cᵣ₁₁ are greater and the Gain is smaller.

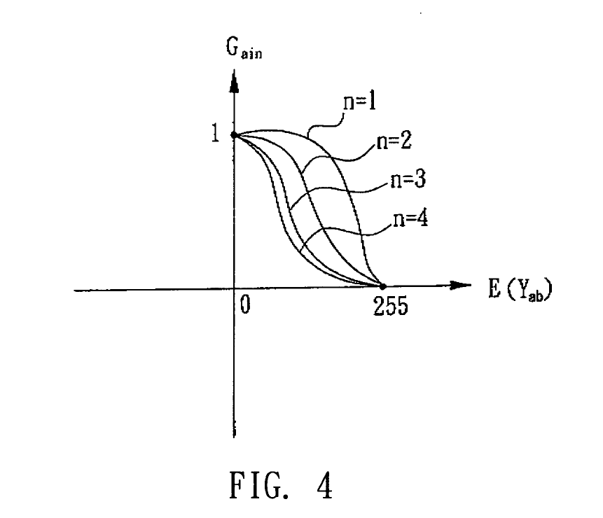

The value of n in the variable parameter (Gain) also determines the modification degree of C_{b11} and Cᵣ₁₁, as shown in FIG. 4. FIG. 4 is a chart showing that the unit luminance difference amount E(Y_{ab}) between the Y_{ab} pixel and its ambient pixels in the digital color image is adjusted according to different variable parameters (Gains). In FIG. 4, it is assumed that the maximum Q of the unit luminance difference amount E(Y_{ab}) between the Y_{ab} pixel and its ambient pixels on the digital color image is 255, and Gain is Cos((E(Y₁₁)÷2Q)π)ⁿ.

When the E(Y_{ab}) value gets greater, the downward modification amounts of C_{bab} and C_{rab} are also greater and the Gain is smaller. Thus, when E(Y_{ab})=255, Gain=0; or otherwise when E(Y_{ab})=0, Gain=1. If the value of n in Gain is 1, the curve distribution of Gain is smooth. If the value of n in Gain is 4, the curve distribution of Gain is steeper as compared to that when the value of n is 1. In other words, if the value of n is greater, the curve of E(Y_{ab}) can vary with E(Y_{ab}) more rapidly. That is, the color edge represented by E(Y_{ab}) can be eliminated more quickly. In the preferred embodiment of the invention, the suitable value of n is 4.

Consequently, the boundary (edge) at the junctional portion between two color blocks on the digital color image is found according to the unit luminance difference amount (E(Y_{ab})) between the pixel Y_{ab} and its ambient pixels on the digital color image. In addition, the degree of the color edge appears at the junctional portion between two color blocks on the digital color image is reduced because the color (C_{bab}, C_{rab}) of the pixel Y_{ab} is eliminated according to E(Y_{ab}) such that the color of the boundary pixel Y_{ab} between two color blocks on the digital color image is extracted out. Thus, the undesired color and the color edge can be avoided.

It is to be noted that while the first and second color factors are adjusted on the basis of the cosine function in the above-mentioned embodiment, the invention is not limited thereto. Any smooth descending function that is properly functionally transferred may be applied to the invention. Besides, the first and second color factors can be adjusted by using a look-up-table, which also falls into the scope of the present invention.

The method disclosed in the embodiment of the present invention can be carried out by an apparatus including a sensor for determining the color representing by a red (R), a green (G), and a blue (B) value of each of the pixels; a converting logic for converting the red, the green, and the blue values into the luminance and the chrominance of each of the pixels; a boundary determining logic for determining a boundary between a first color block and a second color of the digital color image according to a luminance difference of at least a first pixel belonging to the first color block and at least a second pixel adjacent to the first pixel belonging to the second color block; and a chrominance adjusting logic for adjusting the chrominance of at least one of the first and the second pixels according to the luminance difference. It should be noted that the function of each device of the apparatus is described in this specification and people skilled in the art can easily implemented the devices according to the above description of this specification.

In summary, the invention discloses a method and an apparatus for eliminating the color edge by finding a boundary between two color blocks on the digital color image by a high-pass filter. In addition, a smooth descending function serves as a parameter to adjust the color saturation of the boundary pixel between two color blocks on the digital color image. Thus, the color edge on the digital color image is avoided, and the quality of the digital color image is enhanced.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A method for eliminating a color edge on a digital color image, which comprises a plurality of pixels, wherein the color of each pixel is represented by a luminance and a chrominance, the method comprising the steps of:
determining a boundary between a first color block and a second color of the digital color image according to a luminance difference of at least a first pixel belonging to the first color block and at least a second pixel adjacent to the first pixel belonging to the second color block; and
adjusting the chrominance of at least one of the first and the second pixels according to the luminance difference.

2. The method according to claim 1, further comprising the steps of:
determining the color representing by a red (R), a green (G), and a blue (B) value of each of the pixels; and
converting the red, the green, and the blue values into the luminance and the chrominance of each of the pixels.

3. The method according to claim 1, wherein the luminance difference of the first pixel is determined according to the luminance of the first pixel and the luminance of at least one of the pixels adjacent to the first pixel.

4. The method according to claim 3, wherein the luminance difference is determined according to the luminance of the first pixel and the luminances of a second pixel, a third pixel, a fourth pixel and a fifth pixel adjacent to the first pixel, wherein the luminance of the first to fifth pixels are represented by Y₁₁, Y₁₀, Y₁₂, Y₀₁, and Y₂₁, and the luminance difference E (Y₁₁) is:
E(Y₁₁)=(|Y₁₂−Y₁₀|+|Y₂₁−Y₀₁|)÷2.

5. The method according to claim 1, wherein the chrominance is adjusted according to a transfer function with the luminance difference serving as an independent variable.

6. The method according to claim 5, wherein the transfer function is a smooth descending function.

7. The method according to claim 5, wherein the transfer function is a cosine function.

8. The method according to claim 7, wherein the transfer function is a cosine function to an n-th power, and n>1.

9. The method according to claim 8, wherein the transfer function is cos((E(Y1)÷2Q)π)ⁿ, wherein E(Y1) represents the luminance difference of the first color pixel, Q represents the maximum possible value of the luminance difference of each pixel, and n represents the power of the cosine function.

10. The method according to claim 8, wherein n is 4 and Q is 255.

11. The method according to claim 1, wherein chrominance is adjusted according to a look-up-table.

12. The method according to claim 1, wherein the chrominance includes a first color factor (C_{b}) and a second color factor (Cᵣ).

13. An apparatus for eliminating a color edge on a digital color image, which comprises a plurality of pixels, wherein the color of each pixel is represented by a luminance and a chrominance, the apparatus comprising:
a sensor for determining the color representing by a red (R), a green (G), and a blue (B) value of each of the pixels;
a converting logic for converting the red, the green, and the blue values into the luminance and the chrominance of each of the pixels;
a boundary determining logic for determining a boundary between a first color block and a second color of the digital color image according to a luminance difference of at least a first pixel belonging to the first color block and at least a second pixel adjacent to the first pixel belonging to the second color block; and
a chrominance adjusting logic for adjusting the chrominance of at least one of the first and the second pixels according to the luminance difference.

14. The apparatus according to claim 13, wherein the boundary determining logic is a low pass filter.

15. The apparatus according to claim 13, wherein the luminance difference is determined according to the luminance of the first pixel and the luminances of a second pixel, a third pixel, a fourth pixel and a fifth pixel adjacent to the first pixel, wherein the luminance of the first to fifth pixels are represented by Y₁₁, Y₁₀, Y₁₂, Y₀₁, and Y₂₁, and the luminance difference E (Y₁₁) is:
E(Y₁₁)=(|Y₁₂−Y₁₀|+|Y₂₁−Y₀₁|)÷2.

16. The apparatus according to claim 13, wherein the chrominance is adjusted according to a smooth descending function with the luminance difference serving as an independent variable.

17. The apparatus according to claim 16, wherein the smooth descending function is a cosine function to an n-th power, and n≧1.

18. The apparatus according to claim 17, wherein the transfer function is cos((E(Y1)÷2Q)π)ⁿ, wherein E(Y1) represents the luminance difference of the first color pixel, Q represents the maximum possible value of the luminance difference of each pixel, and n represents the power of the cosine function.

19. The apparatus according to claim 18, wherein n is 4 and Q is 255.

20. The apparatus according to claim 13, wherein chrominance is adjusted according to a look-up-table.

21. The apparatus according to claim 13, wherein the chrominance includes a first color factor (C_{b}) and a second color factor (Cᵣ).
